(19) United States
(12) Patent Application Publication
(10) Pub. No.: US 2025/0081957 A1
(43) Pub. Date: Mar. 13, 2025

(54) Crop Sprayers, Liquid Distribution Systems for Crop Sprayers, and Related Methods

(71) Applicant: AGCO Corporation, Duluth, GA (US)

(72) Inventors: Todd Brandon Snyder, Jackson, MN (US); Joseph Paul Anderson, Spirit Lake, IA (US); James McGrath Slawson, Spirit Lake, IA (US)

(21) Appl. No.: 18/291,674

(22) PCT Filed: Jul. 27, 2022
(86) PCT No.: PCT/IB2022/056962

§ 371 Date: Jan. 24, 2024

Related U.S. Application Data
(60) Provisional application No. 63/261,036, filed on Sep. 9, 2021.

(51) Int. Cl. A01M 7/00; A01C 23/00; A01C 23/04

(52) U.S. Cl. CPC A01M 7/0089; A01C 23/007; A01C 23/047; A01M 7/0042; A01M 7/0085

(57) ABSTRACT

A liquid distribution system for a crop sprayer having a laterally extendable boom includes a first product tank configured to contain a first liquid, one or more auxiliary product tank(s) configured to contain an additional liquid(s), a first fluid power source in fluid communication with the first product tank, a pressurized air source in fluid communication with the auxiliary product tank, at least one mixing valve carried by the boom, and at least one nozzle carried by the boom and configured to receive mixed liquid from the at least one mixing valve. The mixing valve(s) are configured to receive the first liquid and the additional liquid(s), and form the mixed liquid. Crop sprayers and related methods are also disclosed.

### CROSS-REFERENCE TO RELATED APPLICATION

This application claims the benefit of the filing date of U.S. Provisional Patent Application 63/261,036, “Crop Sprayers, Liquid Distribution Systems for Crop Sprayers, and Related Methods,” filed Sep. 9, 2021, the entire disclosure of which is incorporated herein by reference.

### FIELD

Embodiments of the present disclosure relate generally to plumbing for a boom arm on a crop sprayer, and more particularly to liquid distribution systems connecting spray nozzles along the boom arm.

### BACKGROUND

High crop yields of modern agribusiness may require application of fertilizers, pesticides, and/or herbicides. Dispersing these chemicals onto high-acreage fields requires specialized machines mounted on or towed by a vehicle. An example of such a machine is the self-propelled sprayer.

A common design for a self-propelled crop sprayer includes a chassis with a tank, boom arms, and nozzles connected to the boom arms. The tank contains liquid product such as fertilizers, pesticides, and/or herbicides. Boom arms extend outward from the sides of the chassis. Boom plumbing contains supply lines and nozzles spaced apart along the length of the boom arms at a spacing distance corresponding to the spray pattern of the nozzles. In operation, as the crop sprayer crosses the field, liquid is pumped from the tank through the supply lines along the boom arms, and out through the nozzles. This allows the self-propelled sprayer to distribute the liquid along a relatively wide path. The length of conventional boom arms may vary from, for example, 6 meters (18 feet) up to 46 meters (150 feet), but shorter or longer booms are possible. The boom arms typically swing in for on-road transport and out for field-spraying operations.

Conventionally, the nozzles are connected in series such that the product flows through a pipe and/or hose from one nozzle to another. Booms have been of the “wet boom” type, where the boom comprises a frame member with a pipe mounted thereon, where the liquid passes through the pipe into nozzles mounted on the pipe and liquidly connected thereto, or a “dry boom” type, where the nozzles are mounted to the frame member and liquid passes to the nozzles through a hose which is connected between the nozzles. The nozzles are attached to the pipe or frame with brackets at desired intervals along the boom arm.

When a sprayer is first used to dispense a particular product, the product may be flushed through the pipe or hose to each nozzle to fill entire plumbing system with the product. This may help to remove air bubbles and ensure that any prior products are purged from the system. To avoid uneven distribution of the product, this flushing and purging process may be performed before the sprayer enters the planted area of the field. This process may dispense several gallons of product out of the boom to ensure that all of the air is out of the boom and that liquid product can consistently and evenly be dispensed from each of the nozzles.

### BRIEF SUMMARY

In some embodiments, a liquid distribution system for a crop sprayer having a laterally extendable boom includes a first product tank configured to contain a first liquid, at least one auxiliary product tank configured to contain an additional liquid, a pressurized air source in fluid communication with the auxiliary product tank, at least one mixing valve carried by the boom, and at least one nozzle carried by the boom and configured to receive mixed liquid from the at least one mixing valve. The at least one mixing valve is configured to receive the first liquid from the first product tank, receive the additional liquid from the auxiliary product tank, and mix the first liquid with the additional liquid to form the mixed liquid.

The liquid distribution system may also include a first flowmeter configured to measure a flow rate of the first liquid to the mixing valve. The liquid distribution system may include at least one additional flowmeter configured to measure a flow rate of the additional liquid to the at least one mixing valve. The at least one mixing valve may include a first mixing valve and a second mixing valve, each configured to receive the first liquid and the additional liquid independent of the other mixing valve.

The at least one nozzle may include a plurality of nozzles configured to receive the mixed liquid from the at least one mixing valve. In some embodiments, each nozzle includes a check valve to enable flow through the respective nozzle when a pressure at the respective nozzle exceeds a threshold.

In some embodiments, the boom includes a plurality of boom arms, and the at least one mixing valve includes a plurality of mixing valves. In such embodiments, each boom arm may carry one or more mixing valves.

The liquid distribution system may include a plurality of nozzles carried by one of the boom arms, and at least some of nozzles carried by the one of the boom arms is fluidly connected to a respective mixing valve carried by the one of the boom arms.

In some embodiments, the liquid distribution system includes a plurality of nozzles and a plurality of mixing valves, and each nozzle is fluidly connected to a respective mixing valve.

The liquid distribution system may include a control system configured to selectively control flows of the first liquid and the additional liquid to the at least one mixing valve.

In certain embodiments, a crop sprayer includes a chassis, a boom carried by the chassis, and a liquid distribution system, such as those described above, carried by the chassis. The crop sprayer may also include an engine carried by the chassis, wherein the engine is configured to propel the chassis through an agricultural field. The crop sprayer may also include an operator cab carried by the chassis.

In some embodiments, the crop sprayer may be a pull-type sprayer, and may include a hitch configured to couple the chassis to a tractor.

Some embodiments include methods of operating a crop sprayer that includes a first product tank, at least one auxiliary product tank, at least one mixing valve carried by a boom, and a plurality of nozzles spaced along the boom. Such methods include delivering a first liquid from the first product tank to the at least one mixing valve, delivering an additional liquid by a pressurized air source from the auxiliary product tank(s) to the at least one mixing valve, combining the first liquid with the at least one additional liquid to form a mixed liquid, and spraying the mixed liquid through at least one of the nozzles.

Some methods may also include measuring a flow rate of the first liquid to the mixing valve, and/or measuring a flow rate of the additional liquid to the mixing valve.

Methods may also include maintaining a pressure in the auxiliary product tank(s). The methods may also include opening at least one valve to enable the additional liquid(s) to flow to the mixing valve. In some embodiments, methods may also include controlling a position of the at least one valve to control a flow rate of the additional liquid(s) to the mixing valve.

In one embodiment, a non-transitory computer-readable storage medium includes instructions that when executed by a computer associated with a crop sprayer, cause the crop sprayer to deliver a first liquid from a first product tank to at least one mixing valve, deliver at least one additional liquid from at least one auxiliary product tank to the at least one mixing valve, combine the first liquid with the at least one additional liquid to form a mixed liquid, and spray the mixed liquid through at least one nozzle.

Other technical features may be readily apparent to one skilled in the art from the following figures, descriptions, and claims.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 illustrates an agricultural vehicle in the form of a self-propelled crop sprayer;

FIG. 2 illustrates a portion of the agricultural vehicle of FIG. 1 including a boom and part of an application system;

FIG. 3 is a simplified schematic view of a nozzle of the application system shown in FIG. 4;

FIG. 4 is a simplified schematic of the application system of the agricultural vehicle of FIG. 1;

FIG. 5 is a simplified schematic of another application system that may be used in the agricultural vehicle of FIG. 1;

FIG. 6 is a simplified top view of an agricultural vehicle, in the form of a crop sprayer towed by a tractor;

FIG. 7 is a simplified flow chart illustrating a method of operating a crop sprayer, such as the crop sprayer shown in FIG. 1; and

FIG. 8 illustrates an example computer-readable storage medium comprising processor-executable instructions configured to embody one or more of the methods of operating a crop sprayer, such as the method illustrated in FIG. 7.

### DETAILED DESCRIPTION

The illustrations presented herein are not actual views of any crop sprayer or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

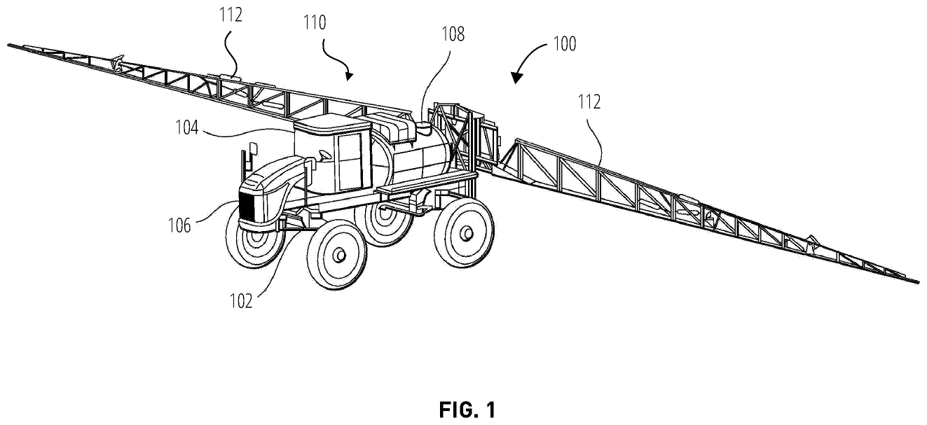

FIG. 1 shows a crop sprayer 100 used to deliver chemicals to agricultural crops in a field. The crop sprayer 100 includes a chassis 102 and an operator cab 104 mounted on the chassis 102. The operator cab 104 may house controls for the crop sprayer 100. An engine 106 may be mounted on a forward portion of chassis 102 in front of the operator cab 104 or may be mounted on a rearward portion of the chassis 102 behind the operator cab 104. The engine 106 may be commercially available from a variety of sources and may include, for example, a diesel engine or a gasoline powered internal combustion engine, a battery-powered electric motor, etc. The engine 106 provides energy to propel the crop sprayer 100 through a field on wheels or tracks, and may also provide energy to spray liquids from the crop sprayer 100.

The crop sprayer 100 further includes one or more product tank 108 to store liquid(s) to be sprayed on the field. The liquid(s) may include water and chemicals, such as but not limited to, herbicides, pesticides, fungicides, and/or fertilizers. The product tank 108 may be mounted on the chassis 102, either in front of or behind the operator cab 104. The crop sprayer 100 may include more than one product tank 108 to store different chemicals to be sprayed on the field. In some embodiments, the product tank 108 may include divided compartments to store different chemicals. The stored chemicals may be dispersed by the crop sprayer 100 one at a time, or different chemicals may be mixed and dispersed together in a variety of mixtures.

A boom 110 on the crop sprayer 100 is used to distribute the liquid from the product tanks 108 over a wide swath as the crop sprayer 100 is driven through the field. The boom 110 may include two or more boom arms 112 that can fold for transport on public roadways, and unfold (i.e., to the position shown in FIG. 1) for field operations.

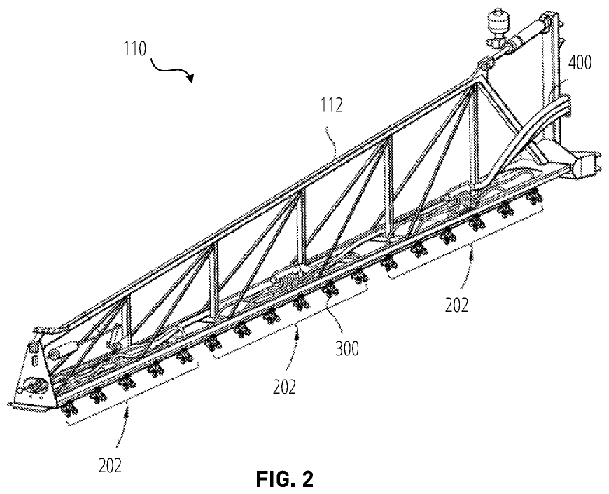

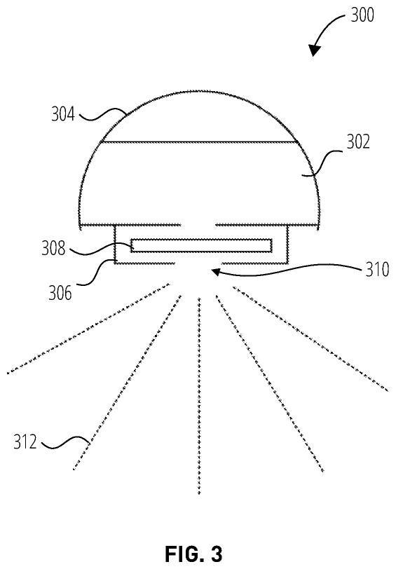

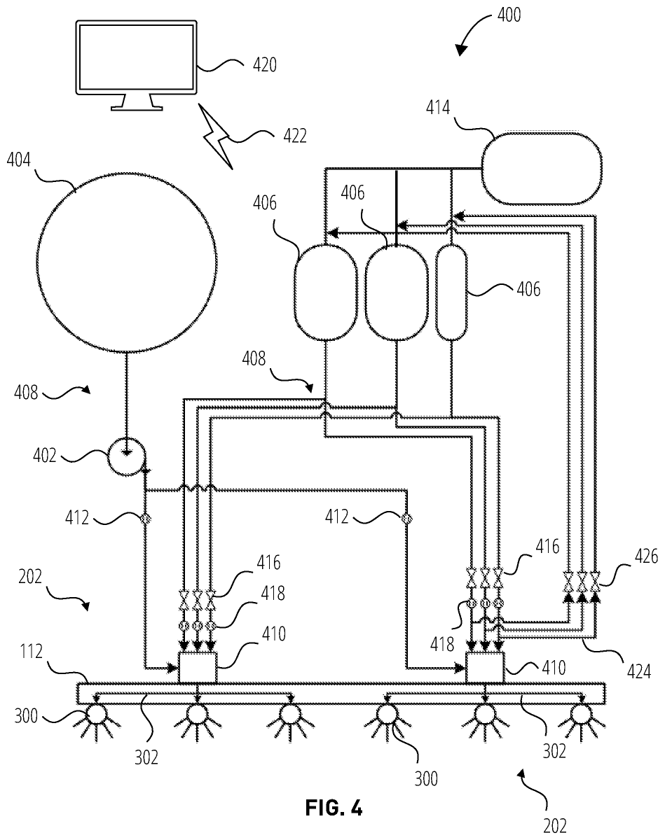

FIG. 2 is a simplified perspective view of a portion of the boom 110. Liquid is conveyed from the product tank 108 (FIG. 1) by a liquid distribution system 400 (depicted in more detail in FIG. 4) to various spray nozzles 300 (one depicted in more detail in FIG. 3) spaced along the boom 110. A portion of the liquid distribution system 400 may be mounted on the boom arm 112 and connect the product tank 108 to the nozzles 300. The nozzles 300 may optionally be grouped into sections 202 of multiple nozzles 300 that are controlled as a group. In other embodiments, each nozzle 300 may be controlled independently, or all nozzles 300 on a boom arm 112 may be controlled together.

FIG. 3 is a simplified schematic view of one of the nozzles 300. As shown, a supply line 302 (i.e., a part of the liquid distribution system 400) may go to or through a nozzle body 304 of the nozzle 300. The nozzle 300 may include a check valve 306 having a diaphragm 308 configured to enable liquid to flow through an orifice 310 in the nozzle body 304 in a liquid spray 312 when the pressure in the supply line 302 exceeds a threshold. Such nozzles 300 are generally used to prevent liquid from dripping from the nozzle 300 when the nozzles 300 are not in use. In other embodiments, the nozzle 300 may include another method of terminating flow and preventing drips, such as an electric valve or air valve.

Each boom arm 112 may typically carry many nozzles 300, such as from about 5 nozzles to about 40 nozzles, without limitation. Each nozzle 300 or group of nozzles 300 may also include an air pressure source, pump, or other metering source to control flow through the nozzles 300.

FIG. 4 is a simplified schematic illustrating how the liquid distribution system 400 may be configured. The liquid distribution system 400 includes a first product tank 404, at least one auxiliary product tank 406 (three depicted in FIG. 4), and components and liquid flow lines 408 to connect the first product tank 404 and the auxiliary product tank 406 to at least one mixing valve 410, and ultimately, to the nozzles 300. “Auxiliary product tank” refers to a compartment capable of storing a liquid product separate from another liquid. Auxiliary product tanks may be individual containers, or may be compartments within a larger container (e.g., compartments separated by dividers in a single or main product tank of a crop sprayer). For example, the auxiliary product tank 406 and the first product tank 404 may each be compartments within the product tank 108 depicted in FIG. 1. Alternatively, the first product tank 404 may be the product tank 108 depicted in FIG. 1, and the auxiliary product tanks 406 may be separate (e.g., smaller) containers carried by the chassis 102.

The first product tank 404 contains a first liquid for application to a crop field, typically water. The water may be fresh water from a utility, well, river, or other source. In some embodiments, the water may be mixed with one or more other materials, such as a dry chemical or an additive. For example, the water may be mixed with an herbicide. The first liquid may be transferred from the first product tank 404 to the mixing valves 410 by a fluid power source, depicted in FIG. 4 as a pump 402 between the first product tank 404 and the mixing valves 410. The fluid power source may alternatively or additionally be a source of pressurized air to the first product tank 404 to push the first liquid through the liquid flow lines 408. The flow rate of the first liquid to each of the mixing valves 410 may be measured by first flowmeters 412. If the first power source is the pump 402, the pump 402 may control the flow rate of the first liquid. If the first power source is, for example, pressurized air in the first product tank 404, a flow control valve along the liquid flow lines 408 may control the flow rate of the first liquid.

The auxiliary product tanks 406 may contain additional liquids for application to a crop field. The auxiliary product tanks 406 may each hold different liquids, such as fertilizers, pesticides, herbicides, fungicides, etc. Though three auxiliary product tanks 406 are depicted in FIG. 4, the number of auxiliary product tanks 406 may be selected such that the auxiliary product tanks 406 can contain the different liquids that will be applied during a field operation. For example, the liquid distribution system 400 may have one, two, three, four, five, six, etc., auxiliary product tanks 406. Typically, the additional liquids in the auxiliary product tanks 406 may be in concentrated form, such that mixing them with the first liquid (e.g., water) may be required for proper dosing. The auxiliary product tanks 406 (and/or the product tank 108, if the auxiliary product tanks 406 are sections thereof) may be formed of a polymer, stainless steel, or another nonreactive material selected to contain the additional liquids.

A pressurized air source 414 is configured to deliver the additional liquid(s) from the auxiliary product tanks 406 to the mixing valves 410. The pressurized air source 414 is configured to provide pressurized air (or another gas, e.g., nitrogen, argon, etc.) to the auxiliary product tanks 406. The pressurized air source 414 may be or include an air compressor, an electrical or hydraulic pump, a pressure tank, or a mechanical means (e.g., a bellows) that can provide pressurized air. The pressurized air source 414 may drive the additional liquids toward the mixing valves 410 when valves 416 on each associated liquid flow line 408 are open. Additional flowmeters 418 may be configured to measure the flow of each additional liquid to each of the mixing valves 410.

The first flowmeter 412 and the additional flowmeters 418, if present, may be configured to send signals 422 to a computer 420 associated with the liquid distribution system 400. The computer 420 may be configured to receive the signals 422 from the flowmeters 412, 418, and send control signals 422 to the pump 402 and valves 416 to control the amount of each liquid flowing to the mixing valves 410.

In some embodiments, the system 400 may include return lines 424 connected to an input to the mixing valves 410. Though only one set of return lines 424 (i.e., a set of return lines 424 for a single mixing valve 410) is depicted in FIG. 4 for simplicity, it should be understood that similar return lines 424 may be connected before each mixing valve 410, such that flow through the return lines 424 can purge the flow lines 408 without expelling the additional liquid through the nozzles 300 (e.g., onto the ground or into a disposal container or facility). The supply lines 424 may be connected to return valve(s) 426 configured to open when material is to be returned to the auxiliary product tanks 406.

Typically, the computer 420 may be in the operator cab 104 of the crop sprayer 100 such that an operator can control the computer 420, but the computer 420 may alternatively be located elsewhere on the crop sprayer 100 or at a remote location (e.g., a farm office). The computer 420 can vary the flow rates of the liquids and therefore the compositions of the mixed liquid leaving the mixing valves 410. Thus, the computer 420 may change the composition of the mixed liquid during spraying operations. For example, when the crop sprayer 100 passes from an area in which the crop material is in good health to an area in which the crop material is in poor health, the computer 420 may change which of the additional liquids to apply, may change the concentrations of the additional liquids, and/or may change the total amount of mixed liquid applied. Furthermore, if the system includes return lines 424, the computer 420 may purge the supply lines 302 when changing the additional liquid to be applied.

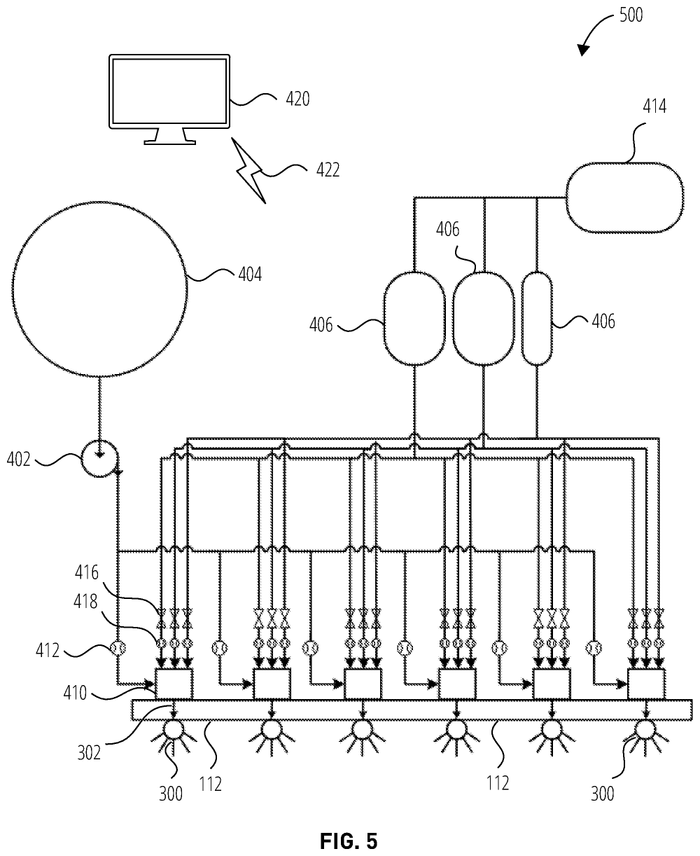

FIG. 5 is a simplified schematic illustrating how another liquid distribution system 500 may be configured. The liquid distribution system 500 differs from the liquid distribution system 400 (FIG. 4) in that each of the nozzles 300 is has a separate mixing valve 410. The liquid distribution system 500 includes more first flowmeters 412, valves 416, additional flowmeters 418, and mixing valves 410 than the liquid distribution system 400, but this complexity may enable individual control of each nozzle 300, and may shorten the length of each of the supply lines 302. Thus, each nozzle 300 can spray a different composition (formed by differing flow rates of the first liquid and the additional liquids). Furthermore, each of the liquid flow lines 408 from the pump 402 may include a flow control valve controlled by the computer 420. Each mixing valve 410 may have corresponding return line(s), such as the return lines 424 shown in FIG. 4. Such return lines are omitted from FIG. 5 for simplicity and clarity.

A benefit of the liquid distribution systems 400, 500 that include mixing valves 410 is that each of the mixing valves 410 may deliver mixed liquids with different compositions to fine-tune the liquid application process to different parts of the field.

Furthermore, because the mixing valves 410 are located relatively closer to the nozzles 300 on the boom arms 112 than in conventional systems, and because the liquid flow lines 408 are primarily located upstream of the mixing valves 410, the volume of liquid flow required to clean or purge the lines (which are typically purged with the first liquid from the first product tank 404) between product applications may be smaller than in conventional systems. That is, the volume of mixed liquid that must be purged when changing from one liquid composition to another is the volume of the supply lines 302 connecting the mixing valves 410 to the nozzles 300. The liquid in the liquid flow lines 408 leading to the mixing valves 410 does not typically change composition during a field operation, and thus, does not need to be purged to switch the mixed liquid from one composition to another. Instead, the composition of the mixed liquid can be changed simply by changing the flow rate to the mixing valves 410 of the first liquid and/or the additional liquids using the pump 402 and/or the valves 416. Furthermore, each section 202 of nozzles 300 (in FIG. 4) or each nozzle 300 (in FIG. 5) can be individually purged and changed to different compositions, if desired.

Thus, it may be relatively faster and easier to purge the mixed liquid than in conventional systems. Furthermore, a small volume to be purged limits the amount of the first liquid consumed in the purging process, and limits the amount of waste generated, which may lead to lower costs of using the crop sprayer 100 as compared to conventional sprayers.

A benefit of using a pressurized air source 414 to deliver the additional liquid(s) is that pressurized air can enable better clean-out than electric or other pumps. Typically, an electric pump operates when the line is full of liquid. Pressurized air can push liquids through the liquid flow lines 408 even as the liquid empties out of liquid flow lines 408. For chemicals that are expensive and/or difficult to dispose of, this difference can translate into cost savings for the operator.

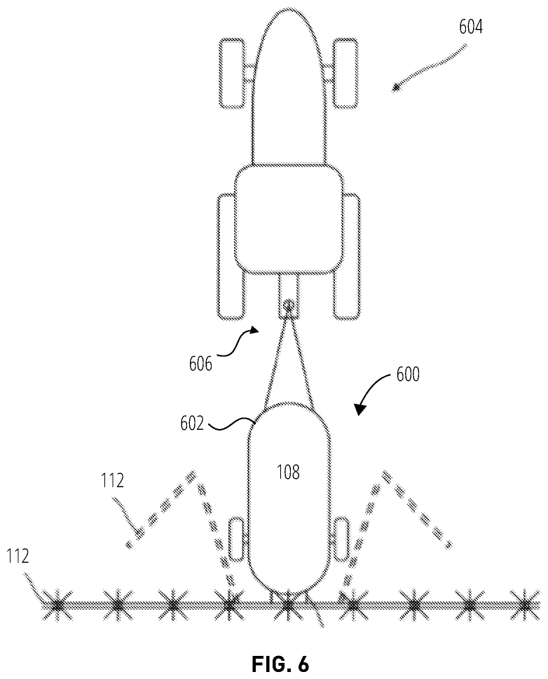

FIG. 6 shows another crop sprayer 600 that may be used to deliver chemicals to agricultural crops in a field. The crop sprayer 600 is a pull-type sprayer pulled by a tractor 604, including a chassis 602 carrying the product tanks 108. The crop sprayer 600 has a hitch 606 configured to couple the chassis 602 to the tractor 604. The tractor 604 may pull the crop sprayer 600 through the field, and the operator of the tractor 604 may also operate the crop sprayer 600 via a control system in the cab of the tractor 604. The boom arms 112 may fold for road transport (dashed lines in FIG. 6 indicate the boom arms 112 folding for transport). The crop sprayer 600 may include the liquid distribution system 400 or 500 as shown in FIG. 4 and FIG. 5, and described above. Portions of the liquid distribution system 400, 500 may be carried by the tractor 604, such as the computer 420. In some embodiments, the computer 420 may be omitted, and the liquid distribution system 400, 500 may be controlled by a user interface built in to the tractor 604.

In some embodiments, the liquid distribution system 400 or 500 may be carried by an automated driverless vehicle (robot), also known in the art as an autonomous agricultural machines (AAM). AAMs may be able to operate around the clock with or without human surveillance. Because no operator is on board, certain parts present in the sprayer 100 may be omitted from an AAM (e.g., the operator cab 104), and others may remain (e.g., the chassis 102, the product tank 108, the boom 110, etc.). For example, U.S. Pat. No. 11,076,525, “Self-Propelled Seed Planter,” granted Aug. 3, 2021, discloses an AAM in the form of a planter having a chassis propelled by four motorized wheels which are powered by an on-board battery pack, and some principles disclosed therein may be applied to an AAM having the liquid distribution systems 400, 500 shown in FIGS. 4 and 5 of the present disclosure.

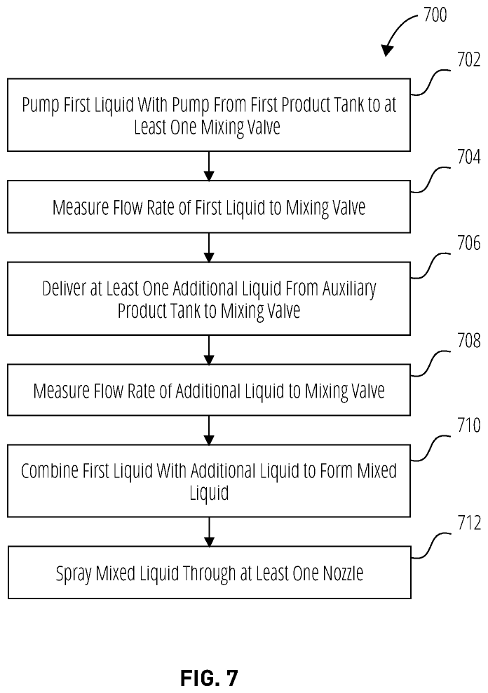

FIG. 7 is a simplified flow chart illustrating a method 700 of operating the crop sprayer 100 (FIG. 1) or the crop sprayer 600 (FIG. 6) in an agricultural field. The crop sprayer includes a pump, a first product tank, a plurality of auxiliary product tanks, at least one mixing valve carried by a boom, and a plurality of nozzles spaced along the boom.

In block 702, the method includes pumping a first liquid from the first product tank to the mixing valve(s) with the pump. Block 704 represents measuring a flow rate of the first liquid to the mixing valve. In block 706, at least one additional liquid is delivered from at least one of the auxiliary product tanks to the mixing valve(s), such as by a pressurized air source.

Block 708 represents measuring a flow rate of the additional liquid(s) to the mixing valve. In block 710, the first liquid is combined with the additional liquid(s) to form a mixed liquid. In block 712, the mixed liquid is sprayed through at least one of the nozzles.

Though depicted as a flow chart, the actions in FIG. 7 may be performed concurrently or in any order, and in some embodiments, some actions may be omitted.

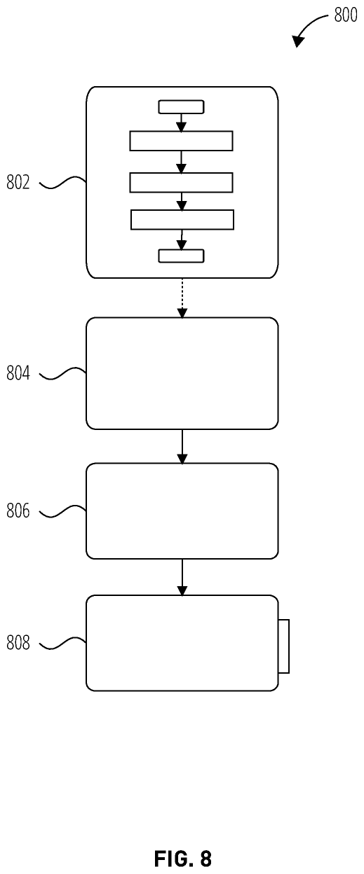

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 8, wherein an implementation 800 includes a computer-readable storage medium 802 (e.g., a flash drive, CD-R, DVD-R, application-specific integrated circuit (ASIC), field-programmable gate array (FPGA), a platter of a hard disk drive, etc.), on which is computer-readable data 804. This computer-readable data 804 in turn includes a set of processor-executable instructions 806 configured to operate according to one or more of the principles set forth herein. In some embodiments, the processor-executable instructions 806 may be configured to cause a computer associated with the crop sprayer 100 (FIG. 1) or crop sprayer 600 (FIG. 6) to perform operations 808 when executed via a processing unit, such as at least some of the example method 700 depicted in FIG. 7. In other embodiments, the processor-executable instructions 806 may be configured to implement a system, such as at least some of the example crop sprayers 100, 600. For example, the computer 420 (FIG. 4) may include or be in communication with the implementation 800 of FIG. 8. Many such computer-readable storage media may be devised by those of ordinary skill in the art that are configured to operate in accordance with one or more of the techniques described herein.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventor. Further, embodiments of the disclosure have utility with different and various machine types and configurations.

1. A liquid distribution system for a crop sprayer having a laterally extendable boom, the system comprising:
a first product tank configured to contain a first liquid;
at least one auxiliary product tank configured to contain an additional liquid;
a pressurized air source in fluid communication with the at least one auxiliary product tank;
at least one mixing valve carried by the boom and configured to receive the first liquid from the first product tank, receive the additional liquid from the at least one auxiliary product tank, and mix the first liquid with the additional liquid to form a mixed liquid; and
at least one nozzle carried by the boom and configured to receive the mixed liquid from the at least one mixing valve.

2. The liquid distribution system of claim 1, further comprising a first flowmeter configured to measure a flow rate of the first liquid to the mixing valve.

3. The liquid distribution system of claim 1, further comprising at least one additional flowmeter configured to measure a flow rate of the additional liquid to the at least one mixing valve.

4. The liquid distribution system of claim 1, wherein the at least one mixing valve comprises a first mixing valve and a second mixing valve, and wherein each mixing valve is configured to receive the first liquid and the additional liquid independent of the other mixing valve.

5. The liquid distribution system of claim 1, wherein the at least one nozzle comprises a plurality of nozzles configured to receive the mixed liquid from the at least one mixing valve.

6. The liquid distribution system of claim 1, wherein each of the at least one nozzle comprises a check valve to enable flow through the respective nozzle when a pressure at the respective nozzle exceeds a threshold.

7. The liquid distribution system of claim 1, wherein the boom comprises a plurality of boom arms, and wherein the at least one mixing valve comprises a plurality of mixing valves, wherein each boom arm carries a mixing valve of the plurality.

8. The liquid distribution system of claim 7, wherein the at least one nozzle comprises a plurality of nozzles carried by one of the boom arms, and wherein at least some of the plurality of nozzles carried by the one of the boom arms are fluidly connected to a respective mixing valve carried by the one of the boom arms.

9. The liquid distribution system of claim 1, wherein the at least one nozzle comprises a plurality of nozzles, wherein the at least one mixing valve comprises a plurality of mixing valves, and wherein each nozzle of the plurality is fluidly connected to a respective mixing valve.

10. The liquid distribution system of claim 1, further comprising a control system configured to selectively control flows of the first liquid and the additional liquid to the at least one mixing valve.

11. The liquid distribution system of claim 1, further comprising a pump along a liquid flow line connecting the first product tank to the at least one mixing valve.

12. The liquid distribution system of claim 1, further comprising at least one return line connecting an input to the at least one mixing valve with the at least one auxiliary product tank.

13. (canceled)

14. The crop sprayer of claim 23, further comprising an engine carried by the chassis, the engine configured to propel the chassis through an agricultural field.

15. The crop sprayer of claim 23, further comprising an operator cab carried by the chassis.

16. (canceled)

17. A method of operating a crop sprayer comprising a first product tank, at least one auxiliary product tank, at least one mixing valve carried by a boom, and a plurality of nozzles spaced along the boom, the method comprising: delivering a first liquid from the first product tank to the at least one mixing valve;
delivering an additional liquid by a pressurized air source from the at least one auxiliary product tank to the at least one mixing valve;
combining the first liquid with the at least one additional liquid to form a mixed liquid; and
spraying the mixed liquid through at least one of the nozzles.

18. (canceled)

19. (canceled)

20. The method of claim 19: claim 17, wherein delivering an additional liquid from at least one auxiliary product tank to the at least one mixing valve comprises maintaining a pressure in the at least one auxiliary product tank.

21. The method of claim 20, wherein delivering an additional liquid from the at least one auxiliary product tank to the at least one mixing valve further comprises opening at least one valve to enable the additional liquid to flow to the at least one mixing valve.

22. The method of claim 21, further comprising controlling a position of the at least one valve to control a flow rate of the additional liquid to the at least one mixing valve.

23. A crop sprayer, comprising:
a chassis;
a boom carried by the chassis;
a first product tank carried by the chassis and configured to contain a first liquid;
at least one auxiliary product tank configured to contain an additional liquid;
a pressurized air source in fluid communication with the at least one auxiliary product tank;
at least one mixing valve carried by the boom and configured to receive the first liquid from the first product tank, receive the additional liquid from the at least one auxiliary product tank, and mix the first liquid with the additional liquid to form a mixed liquid; and
at least one nozzle carried by the boom and configured to receive the mixed liquid from the at least one mixing valve.

24. A non-transitory computer-readable storage medium, the computer-readable storage medium including instructions that when executed by a computer associated with a crop sprayer, cause the crop sprayer to:
deliver a first liquid from a first product tank to at least one mixing valve;
deliver an additional liquid by a pressurized air source from at least one auxiliary product tank to the at least one mixing valve;
combine the first liquid with the additional liquid to form a mixed liquid; and
spray the mixed liquid through at least one nozzle.
